(19) United States
(12) Patent Application Publication
(10) Pub. No.: US 2011/0138003 A1
(43) Pub. Date: Jun. 9, 2011

(54) SYSTEM AND METHOD FOR PROVIDING OFFLINE BASED SIMPLE SOCIAL NETWORK SERVICE

(75) Inventors: Sunghyun YOON, Daejeon (KR); Soon Seok Lee, Daejeon (KR); Young Boo Kim, Gongju (KR)

(73) Assignee: Electronics and Telecommunications Research Institute, Daejeon (KR)

(21) Appl. No.: 12/962,269

(22) Filed: Dec. 7, 2010

(30) Foreign Application Priority Data
Dec. 7, 2009 (KR) 10-2009-0120544
Nov. 24, 2010 (KR) 10-2010-0117665

(51) Int. Cl. G06F 15/16

(52) U.S. Cl. 709/206

(57) ABSTRACT

In order to provide an offline-based social network service from a social network service system to a plurality of terminals, an online history identifier corresponding to an offline event is transmitted to a first terminal when an online history identifier creation request message is received from the first terminal that creates the offline events among the plurality of terminals. a participant registration confirming message is transmitted to the first terminal when information on a participant list including a second terminal is received from the first terminal, and the created online history identifier is transmitted to the second terminal, thereby providing the offline-based social network service to the first terminal and the second terminal.

### CROSS-REFERENCE TO RELATED APPLICATION

This application claims priority to and the benefit of Korean Patent Application No. 10-2009-0120544 and No. 10-2010-0117665 filed in the Korean Intellectual Property Office on Dec. 7, 2009 and Nov. 24, 2010, the entire contents of which are incorporated herein by reference.

### BACKGROUND OF THE INVENTION

(a) Field of the Invention

The present invention relates a system and method for providing offline based social network service.

(b) Description of the Related Art

A social network is a network made up of individuals based on the relationship between individuals. A Social Network Service is a service helping in building interconnection relation.

Through the Internet, so called the greatest invention of today, offline relations such as regionalism, school relations, and kinship have been advanced to an online social network built up based on common interests. An online social network service includes a café, a blog, a mini home page, and a messenger. Such an online social network service enables a user to publish a personal interest on an online media through Internet, enables others to browse the published interest, and builds a social network by tying individuals having the common interests.

A service provided from the above described online social network service is easy to artificially expand a relation between users by analyzing a profile database and inferring a relation between users. However, there is a limitation to analyze human relations formed through offline events based on personal closeness between users.

Further, there is a great obstacle to support various offline events. For example, an online social network service merely supports publishing announcement prior to an offline event and epilogue after an offline event on a predetermine data, such as a reunion on a Friday night.

That is, an offline event supported by an online social network service requires a participant to have prior knowledge such as an event schedule, an event location, and participation in an event. Eventually, it is difficult to guarantee that an online social network supports an offline event in real-time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for providing an offline based social network service having advantages of providing various online social network services for offline events.

An exemplary embodiment of the present invention provides a system for providing an offline based social network service, including: an event creation/termination confirming unit for confirming whether an offline event is created or not and creating an online history corresponding to the created offline event, and receiving a message of informing termination of an offline event and outputting the received message in order to terminate an online history of the corresponding offline event, an identifier managing unit for generating an online history identifier to create an online history corresponding to a created offline event when the event creation/end confirming unit confirms that the offline event is created, an information managing unit for receiving event information from terminals participating in a plurality of offline events corresponding to a plurality of created online histories and generating termination information that informs termination of a corresponding online history when receiving the message from the event creation/termination confirming unit, and a participant managing unit for managing terminal information of participants of an offline event.

Another exemplary embodiment of the present invention provides a terminal for receiving a social network service from a social network service system including: an identifier issue request unit for requesting the social network service system to issue an online history identifier in order to create an online history corresponding to a created offline event, a participant information registration unit for transferring information on participant terminals of the created offline event to the social network service system, and a history update unit for updating an online history by transferring offline event progress information generated during the offline event.

Still another exemplary embodiment of the present invention provides a method for providing an offline-based social network service from a social network service system to a plurality of terminals.

In the method, an online history identifier creation request message is received from a first terminal that creates an offline event among the plurality of terminals. An online history identifier is created corresponding the offline event and the online history identifier is transmitted to the first terminal. A participant registration confirming message is transmitted to the first terminal when receiving participant list information including second terminal information on a second terminal participating in the offline event from the first terminal. Then, the created online history identifier is transmitted to the second terminal. An offline-based social network service is provided to the first terminal and the second terminal.

Still another exemplary embodiment of the present invention provides a method for receiving an offline-based social network service at a plurality of terminals from a social network service system.

In the method, a first terminal creating an offline event among the plurality of terminals requests the social network service system to create an online history identifier for the created offline event. A participant list of the created offline event is provided when receiving an online history identifier from the social network service system. A participant registration confirming message for the participant list is received from the social network service system. An online history is updated by transmitting information on an offline event to the social network service system.

### BRIEF DESCRIPTION OF THE DRAWINGS

FIG. 1 is a schematic view illustrating supporting an offline event in a typical online social network service system.

FIG. 2 is a configuration diagram illustrating an offline based social network service system according to an exemplary embodiment of the present invention.

FIG. 3 is a configuration diagram illustrating a terminal according to an exemplary embodiment of the present invention.

FIG. 4 is a flowchart illustrating a method for providing an offline based social network service according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising”, will be understood to imply the inclusion of stated elements but not the exclusion of any other elements.

In the specification, a terminal may include a mobile station (MS), a mobile terminal (MT), a subscriber station (SS), a portable subscriber station (PSS), user equipment (UE), access terminal (AT). Further, a terminal may include entire or partial function of a mobile terminal, a subscriber station, a portable subscriber station, and user equipment.

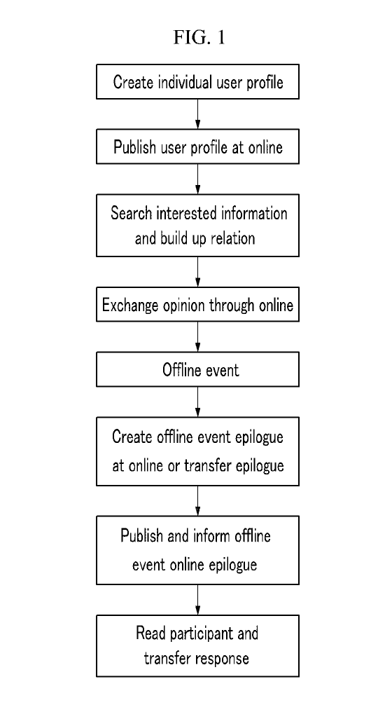

Hereinafter, a method for providing an offline-based social network service according to an exemplary embodiment of the present invention will be described based on the accompanying drawings. Prior to describing an exemplary embodiment of the present invention, a concept of supporting an offline event in a typical online social network service system will be described with reference to FIG. 1.

FIG. 1 is a schematic view illustrating a typical online social network service system.

As shown in FIG. 1, each user creates a profile based on a predetermined profile format using an own terminal according to own needs or in response to requests from others in a typical online social network service system. The predetermined profile format may be defined by the typical online social network service system. The created profile is published according to a method defined in the typical online social network service system. The published profile becomes a search subject to other users who are interested about a subject of the published profile.

Then, each user searches interests on the online social network service system and builds relation with other users having the common interests. After forming a user group having the common interests, a community of corresponding interest is formed and an offline event may be established. In order to setup an offline event, a prior procedure such as gathering opinions may be required to collect participants. Such a prior procedure may be handled by a system for providing an online social network service.

After successfully finishing an offline event, participants publish various opinions about the corresponding offline event. When the participants create epilogue in general, such an epilogue includes a date, a location, a purpose, participants, a result, progress details, and expenses. Further, the epilogue may include various types of information including multimedia such as images created by participants during the event.

The online social network service system delivers the created epilogue to each participant. The online social network service system may store the corresponding contents of the epilogue and informs participants of a method for accessing the stored epilogue.

After informing the access method, each participant reads the corresponding contents according to a proper access method and publishes response to inform other participants of own thought of the corresponding offline event. As described above, the typical online social network service system merely support the prior procedure and the post procedure of the offline event.

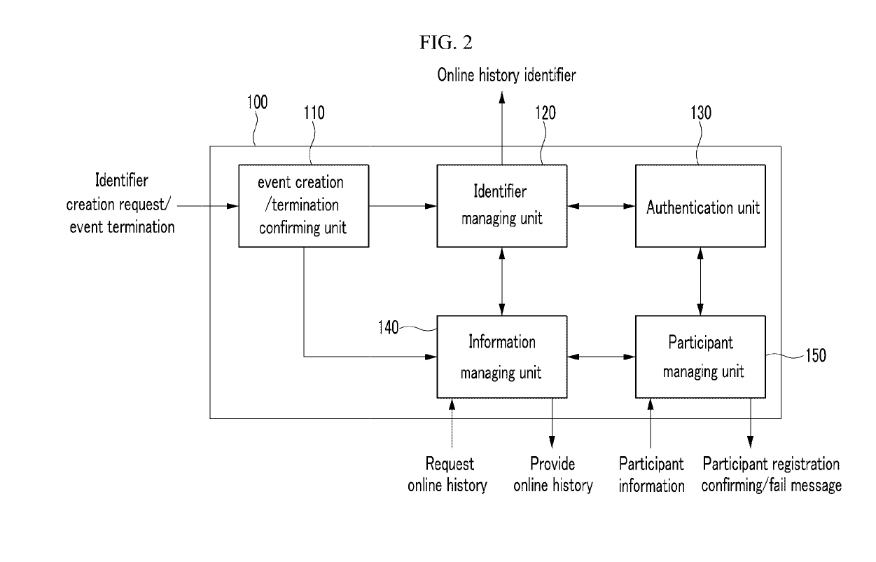

Hereinafter, a social network service system, a terminal, and a method for processing an offline event using an online system will be described with reference to FIG. 2 to FIG. 4.

FIG. 2 is a configuration diagram illustrating an offline based social network service system according to an exemplary embodiment of the present invention.

As shown in FIG. 2, the offline based social network service system 100 includes an event creation/termination confirming unit 110, an identifier managing unit 120, an authentication unit 130, an information managing unit 140, and a participant managing unit 150.

The event creation/termination confirming unit 110 confirms creation and termination of an offline event. The creation of offline event may be confirmed when a predetermined user creates an event at offline. That is, the creation of offline event is sensed when the predetermined user requests the social network service system 100 to create an identifier of a corresponding offline event using a terminal of the predetermined user.

When the event creation/termination confirming unit 110 receives a message informing the end of an offline event through the terminal of the predetermined user who created the event, the event creation/termination confirming unit 110 informs the information managing unit 140 to terminate an online history corresponding to the offline event. Then, the event creation/termination confirming unit 110 transmits a message informing the termination of the online history to terminals of participants as well as to the terminal that informed the end of offline event. The purpose of the online history is to effectively support the offline event. Accordingly, the participants can continuously use the online history although the online history is terminated.

The identifier manager 120 creates an online history identifier for managing an online history corresponding to an event when it is sensed that the event creation/termination confirming unit 110 creates an event. After creating the online history identifier, the identifier manager 120 transmits the created online history identifier to the terminal 200. There may be many methods for creating an online history identifier. In an exemplary embodiment of the present invention, such methods are not limited to a specific method. The online history is information created corresponding to the offline event and stored at online.

In an exemplary embodiment of the present invention, the online history identifier may be created by an event creator in consideration of a purpose of an offline event, a data of an offline event, a range of participation. Further, the online history identifier may be created using a tagging method based on an easy and searchable keyword. Moreover, the system may add a time stamp, a terminal access path, and a keyword extract scheme to the online history identifier created by the event creator.

The authentication unit 130 authenticates whether the online history is provided only to participants of the offline event or provided to all user registered at the social network service system 100 when the online history is provided to users after the offline event ends. That is, the user access to the online history after the offline event is limited according to a policy defined in the social network service.

Such authentication may be progressed through various methods. The authentication method according to an exemplary embodiment of the present invention is not limited to one specific method. For authentication, the authentication unit 130 receives information on participants or information on users registered at the social network service system 100 from the participant managing unit 150.

Further, the authentication unit 130 authenticates whether to allow accessing the online history to users interested about the offline event among registered users who do not participate in the offline event during the offline event. Such an authentication method is not to limit participation in predetermined offline events for unspecified individuals, such as assemblies, protests, signature-seeking events, and street-cheering events although it is preferable to allow only the participants of the offline event to access the online history.

The information managing unit 140 stores and manages a mess amount of information created and transmitted through terminals of participants for each published online history. The information includes various types of information such as an epilogue after an offline event and other opinions. Information on the end of the offline event is published on a corresponding online history when the message informing the end of the offline event is received from the event creation/termination confirming unit 110. However, the online history is updated after the offline event ends if information is received from a terminal 200 of an authenticated user.

The participant managing unit 150 identifies offline event participants among users of the social network service and manages information on each participant. The participant managing unit 150 transfers the participant information to the authentication unit 130 in order to limit information collection of a corresponding online history when the online social network service system 100 has an access restriction policy. The participant managing unit 150 transmits a participant registration confirming message to the terminal 200 in order to inform that information on participants of the offline event is registered.

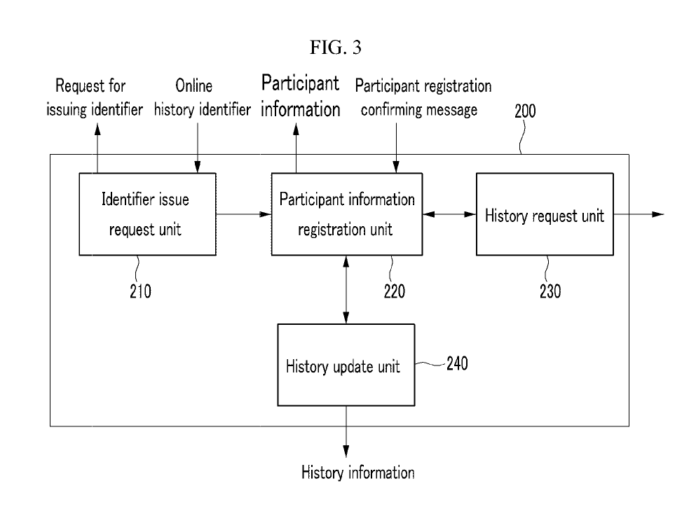

Hereinafter, a user terminal for receiving the online social network service according to an exemplary embodiment of the present invention will be described with reference to FIG. 3.

FIG. 3 is a configuration diagram illustrating a terminal according to an exemplary embodiment of the present invention.

As shown in FIG. 3, the terminal 200 includes an identifier issue request unit 210, a participant information registration unit 220, a history update unit 240, and a history request unit 230.

The identifier issue request unit 210 generates a request signal to request an identifier indicating that a published online history is not duplicated when an offline event creator publishes an online history on the social network service system 100 using the terminal 200. The identifier issue request unit 210 receives and stores an online history identifier provided from the social network service system 100.

The stored online history identifier may be used to search the online history after the offline event ends. The identifier issue request signal includes information on an offline event name and an offline event date.

The participant information registration unit 220 transfers information on participants of the offline event to the social network service system 100. The participant information registration unit 220 receives a participant registration confirming message from the social network service system 100. The participant information includes information on a participant terminal number and a participant name. In an exemplary embodiment of the present invention, it is described that the terminal of the offline event creator transmits the participant information. However, the identifier issue request unit 210 may transmit only a name of a participant when the online history identifier is requested to issue and the social network service system 100 may automatically collect other information on the participant.

The history update unit 240 transfers information on offline event progress details created during the offline event to the social network service system 100 and updates the online history in real-time. The offline event progress detail information includes various types of information such as the progress of the offline event and the updates of participants.

When participants or uses registered at the social network service system 100 request to read history information of offline events, the history request unit 230 may receives a request from a user and provide an online history stored in the social network service system 100. Only authenticated participants or user may be provided with an online history. When the offline event ends, the social network service system 100 is requested to terminate the online history.

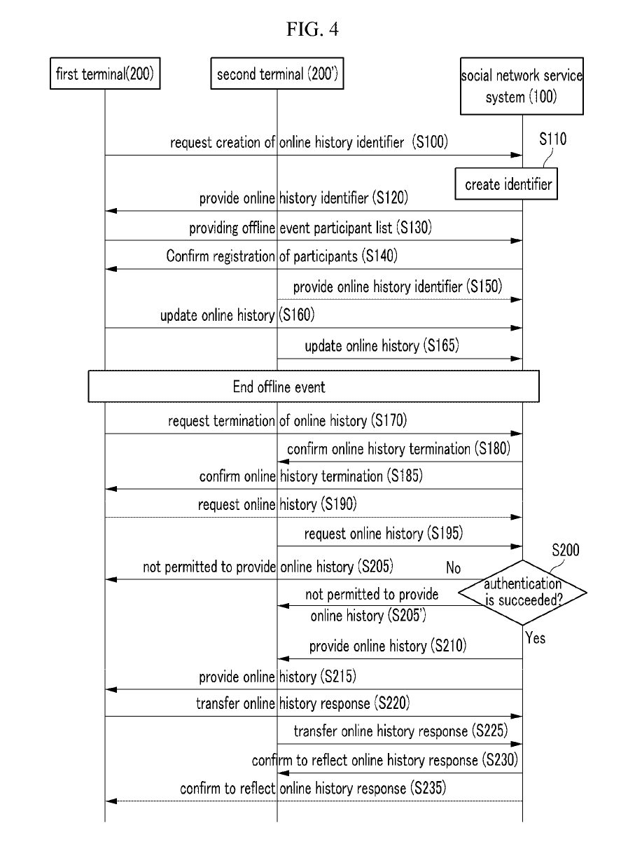

Hereinafter, a method for providing a service through the social network service system and the terminal according to an exemplary embodiment of the present invention will be described with reference to FIG. 4. In an exemplary embodiment of the present invention, it is assumed that a user of a first terminal initially creates an offline event and a participant owns a second terminal.

FIG. 4 is a flowchart illustrating a method for providing an offline-based social network service according to an exemplary embodiment of the present invention.

As shown in FIG. 4, when a user of a first terminal 200 creates an offline event and registers the created offline event at the social network service system 100, the identifier issue request unit 210 of the first terminal 200 transmits a message of requesting creation of an online history identifier to the social network service system 100 at step S100.

At step S110, the event creation/termination confirming unit 110 of the social network service system 100 receives the request message, senses an event created at offline, and the identifier managing unit 120 creates an online history identifier for a corresponding event. The method of creating the online history identifier in the identifier managing unit 120 is not limited to one specific method.

At step S120, the identifier managing unit 120 stores the created online history identifier at the information managing unit 140 and transmits the created online history identifier to the first terminal 200. The identifier managing unit may transmit a method of accessing an online history as well as the created online history identifier. The online history accessing method is transferred with the created online history identifier to participants who want to individually access the online history. Accordingly, each participant may access the online history using the transferred online history accessing method and the online history identifier.

At step S130, the participant information registration unit 220 of the first terminal 200 receives the online history identifier and transmits participant information on users participating in an offline event to the social network service system 100. The participant information may include a participant name, a terminal number of participants' terminal, and terminal information thereof.

Meanwhile, an online history creator may create a participant list and transmit the participant list to the social network service system. However, the online history creator may inform participants of an online history identifier and an access method using an offline method such as orally due to characteristics of an offline event. In this case, the offline participants may individually access the online history. However, an additional authentication method such as an authentication code may be required to control accessing of participant to the online history. Such an authentication method may be included in a process of creating an online history.

At step S140, the participant information registration unit 220 transmits a participant registration confirming message to the terminal 200 in order to inform that participant information is registered. Simultaneously at step S150, the created online history identifier created by the identifier managing unit 120 at the step S110 is transmitted to a second terminal 200′ belonging to a participant based on the terminal number information included in the participant information in order to inform the second terminal 200′ to have a right to access the online history. The step S150 may prevent the duplication of identical online history because any participant may create an online history. Further, it may enable authenticated users and participants to search and be provided with the online history after the offline event ends.

It is assumed that the first and second terminals 200 and 200′ of the participants of the same offline event have the same online history identifier and one or both of the first and second terminals 200 and 200′ tries to register information or opinion for the offline event at the social network service system 100 during the offline event. At steps S160 and 165, the history update unit 240 transmits a message having information on the offline event to the social network service system 100 to update the online history.

When the offline event ends, the online history is terminated according to a predetermined policy. At step S170, the history request unit 230 of the first terminal 200 transmits an online history termination message to inform that the offline event ends. At steps S180 and S185, the event creation/termination confirming unit 110 receives the history termination request message and transmits a message of informing termination of the online history of the offline event to the first terminal 200 and the second terminal 200′. Simultaneously, the information managing unit 140 registers information that informs the end of the offline event corresponding to the online history.

However, the online history may be continuously used regardless of the end of the offline event. That is, at least one of the first and second terminals 200 and 200′ requests the online history of the offline event to the social network service system 100 after the offline event ends at steps S190 and S195, the information managing unit 140 provides the stored and managed online history to the terminal requesting the online history at steps S210 and S215. When the online history is requested at the step S190 or S195, the online history is requested with the online history identifier.

If the social network service system 100 has a policy not to provide an online history to all participants or users, the authentication unit 130 determines whether a terminal 200 or 200′ requesting the online history is allowed to have the online history or not at step S200. At steps S210 and S215, the online history is only provided to a terminal of an authenticated user or an authenticated participant. When an authentication-failed terminal requests the online history, a message of not permitted is transmitted to the terminal at steps S205 and S205′.

When a user adds information after confirming the online history because the online history can be updated after the offline event ends, the history update unit 240 transmits the additional information to the social network service system 100 at steps S220 and S225. At steps S230 and S235, the information managing unit 140 transmits a response confirming message to the terminals 200 and 200′ in order to inform that the information received at the steps S220 and S225 are reflected on the online history.

According to an exemplary embodiment of the present invention, participants are enables to maximally utilize the purpose of an offline event by providing various offline based social network services for offline events. Further, a social network with a further close relation can be effective provide to participants.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing an offline-based social network service comprising:
an event creation/termination confirming unit for confirming whether an offline event is created or not and creating an online history corresponding to the created offline event, and receiving a message of informing termination of an offline event and outputting the received message in order to terminate an online history of the corresponding offline event;
an identifier managing unit for generating an online history identifier to create an online history corresponding to a created offline event when the event creation/end confirming unit confirms that the offline event is created;
an information managing unit for receiving event information from terminals participating in a plurality of offline events corresponding to a plurality of created online histories and generating termination information that informs termination of a corresponding online history when receiving the message from the event creation/termination confirming unit; and
a participant managing unit for managing terminal information of participants of an offline event.

2. The system of claim 1, further comprising:
an authentication unit for authenticating an online history access permission of a terminal that requests an online history after the offline event ends and transferring an online history to the terminal according to the authentication result.

3. A terminal for receiving a social network service from a social network service system comprising:
an identifier issue request unit for requesting the social network service system to issue an online history identifier in order to create an online history corresponding to a created offline event;
a participant information registration unit for transferring information on participant terminals of the created offline event to the social network service system; and
a history update unit for updating an online history by transferring offline event progress information generated during the offline event.

4. The terminal of claim 3, further comprising:
a history request unit for requesting an event history stored in the social network service system after the offline event ends and receiving the requested event history.

5. A method for providing an offline-based social network service from a social network service system to a plurality of terminals, comprising:
receiving an online history identifier creation request message from a first terminal that creates an offline event among the plurality of terminals;
creating an online history identifier corresponding the offline event and transmitting the created online history identifier to the first terminal;
transmitting a participant registration confirming message to the first terminal when receiving participant list information including second terminal information on a second terminal participating in the offline event from the first terminal and transmitting the created online history identifier to the second terminal; and
providing an offline-based social network service to the first terminal and the second terminal.

6. The method of claim 5, further comprising:
after the providing an offline-based social network service,
receiving from the first terminal an online history termination request message that informs termination of an offline event; and
transmitting an online history termination confirming message to the first terminal and the second terminal.

7. The method of claim 6, further comprising:
the transmitting an online history termination confirming message,
authenticating whether a terminal transmitting an online history request message is allowed to access an online history or not when receiving the online history request message from at least one of the first terminal and the second terminal;
providing an online history to the terminal that transmits the online history request message when the terminal is an allowed terminal.

8. A method for receiving an offline-based social network service at a plurality of terminals from a social network service system, comprising:
at a first terminal creating an offline event among the plurality of terminals, requesting the social network service system to create an online history identifier for the created offline event;
providing a participant list of the created offline event when receiving an online history identifier from the social network service system;
receiving a participant registration confirming message for the participant list from the social network service system; and
updating an online history by transmitting information on an offline event to the social network service system.

9. The method of claim 8, further comprising:
after the updating an online history,
at the first terminal, transmitting an online history termination request message to the social network service system after the offline event ends; and
receiving an online history termination confirming message from the social network service system.

10. The method of claim 8, further comprising:
after the receiving a participant registration confirming message for the participant list from the social network service system,
at a second terminal confirmed to be registered as a participant among the plurality of terminals, receiving the online history identifier from the social network service system.
